(19) United States
(12) Patent Application Publication
(10) Pub. No.: US 2026/0229406 A1
(43) Pub. Date: Aug. 6, 2026

(54) MULTILAYER ELECTRONIC COMPONENT

(71) Applicant: SAMSUNG ELECTRO-MECHANICS CO., LTD., Suwon-si (KR)

(72) Inventors: Hye Won KIM, Suwon-si (KR); Han Sol YUN, Suwon-si (KR); Seo Ho LEE, Suwon-si (KR); Gyeong Ju SONG, Suwon-si (KR); Il Ho AN, Suwon-si (KR); Seong Hoon KIM, Suwon-si (KR); Berm Ha CHA, Suwon-si (KR)

(73) Assignee: SAMSUNG ELECTRO-MECHANICS CO., LTD., Suwon-si (KR)

(21) Appl. No.: 19/405,847

(22) Filed: Dec. 2, 2025

(30) Foreign Application Priority Data
Feb. 5, 2025 (KR) 10-2025-0014385

(51) Int. Cl. H01G 2/20; H01G 4/005; H01G 4/232; H01G 4/30

(52) U.S. Cl. CPC H01G 2/20; H01G 4/005; H01G 4/232; H01G 4/30

(57) ABSTRACT

A multilayer electronic component includes a body including a capacitance formation portion including a dielectric layer and an internal electrode layer and a floating electrode layer alternately arranged in a thickness direction with the dielectric layer interposed therebetween and a cover portion disposed on upper and lower surfaces of the capacitance formation portion in the thickness direction, an external electrode including a connection portion disposed on a surface of the body in a length direction and a band portion extending from the connection portion to a portion of a surface in the thickness direction, and an insulating layer including silicon (Si) disposed on the body and the external electrode, wherein the ratio (tc/BL) of an average thickness (tc) of the cover portion to the length (BL) between the band portions may satisfy 0.036≤tc/BL≤1.5.

### CROSS-REFERENCE TO RELATED APPLICATION(S)

This application claims benefit of priority to Korean Patent Application No. 10-2025-0014385 filed on Feb. 5, 2025 in the Korean Intellectual Property Office, the disclosure of which is incorporated herein by reference in its entirety.

### TECHNICAL FIELD

The present disclosure relates to a multilayer electronic component.

Multilayer ceramic capacitors (MLCCs), a type of multilayer electronic component, are chip-shaped capacitors mounted on printed circuit boards of various electronic devices, such as imaging devices including liquid crystal displays (LCDs) and plasma display panels (PDPs), computers, smartphones, cell phones, and the like, to be charged with electricity or discharged.

These multilayer ceramic capacitors are compact, ensure high capacity, and are easy to install, and thus may be used as components for a variety of electronic devices. As various electronic devices, such as computers and mobile devices, have become smaller and more powerful, demand for miniaturized and higher-capacity multilayer ceramic capacitors has increased.

Recently, as demand for multilayer ceramic capacitors for automotive applications has increased, multilayer ceramic capacitors have been increasingly applied to high voltages. However, high-voltage products with relatively high rated voltages have technical challenges due to the risk of arcing between both external electrode terminals caused by a high voltage applied to both ends.

This arcing phenomenon refers to an arc discharge phenomenon in which insulation fails and current leaks occur due to a strong electric field generated as different potentials are formed when high voltage is applied to both conductive external electrodes of a component, which causes the surrounding materials to carbonize. In particular, when ultra-high voltage is applied, the risk of arcing occurring between both external electrode terminals may further increase.

Arcing may change electrical characteristics, such as capacity and reduced insulation resistance (IR), and may damage the appearance of products, thereby accelerating cracking and failure. Therefore, an appropriate design is required to control the formation of an insulating layer and a surface current flow caused by the electrodes to prevent arcing.

### SUMMARY

An aspect of the present disclosure is to provide a multilayer electronic component having excellent reliability in high-voltage environments.

Another aspect of the present disclosure is to provide a multilayer electronic component having excellent moisture resistance.

Another aspect of the present disclosure is to provide a multilayer electronic component having excellent mountability.

Another aspect of the present disclosure is to provide a multilayer electronic component capable of preventing an arcing phenomenon.

However, the problems to be solved by the present disclosure are not limited to the above-described contents and will be more easily understood in the course of describing specific exemplary embodiments of the present disclosure.

According to an aspect of the present disclosure, a multilayer electronic component includes: a body including: a capacitance formation portion including: a dielectric layer; and an internal electrode layer and a floating electrode layer alternately disposed in a thickness direction with the dielectric layer interposed therebetween; and a cover portion disposed on each of first and second surfaces of the capacitance formation portion in the thickness direction, the body including first and second surfaces opposing each other in the thickness direction, third and fourth surfaces connected to the first and second surfaces of the body and opposing each other in a length direction, and fifth and sixth surfaces connected to the first to fourth surfaces of the body and opposing each other in a width direction; a first external electrode including: a first connection portion disposed on the third surface of the body, and a first band portion extending from the first connection portion onto first portions of the first and second surfaces of the body; a second external electrode including: a second connection portion disposed on the fourth surface of the body, and a second band portion extending from the second connection portion onto second portions of the first and second surfaces of the body; and an insulating layer including silicon (Si) disposed on the body, wherein a ratio (tc/BL) of an average thickness tc of the cover portion to a length BL between the first and second band portions satisfies 0.036≤tc/BL≤1.5.

According to another aspect of the present disclosure, a multilayer electronic component includes: a body including: a capacitance formation portion including: a dielectric layer; and an internal electrode layer and a floating electrode layer alternately disposed in a thickness direction with the dielectric layer interposed therebetween; and a cover portion disposed on each of first and second surfaces of the capacitance formation portion in the thickness direction, the body including first and second surfaces opposing each other in the thickness direction, third and fourth surfaces connected to the first and second surfaces of the body and opposing each other in a length direction, and fifth and sixth surfaces connected to the first to fourth surfaces of the body and opposing each other in a width direction; a first external electrode including: a first connection portion disposed on the third surface of the body, and a first band portion extending from the first connection portion onto first portions of the first and second surfaces of the body; a second external electrode including: a second connection portion disposed on the fourth surface of the body, and a second band portion extending from the second connection portion onto second portions of the first and second surfaces of the body; and an insulating layer including silicon (Si) disposed on the body, wherein a ratio, AV/BL, of a voltage AV applied to the multilayer electronic component to a length BL between the first and second band portions satisfies 0.5 V/μm≤AV/BL≤1.2 V/μm.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an exemplary embodiment of the present disclosure;

FIG. 2 is a schematic cross-sectional view taken along line I-I′ of FIG. 1;

FIG. 3 is a schematic cross-sectional view taken along line II-II′ of FIG. 1; and

FIGS. 4A and 4B schematically illustrate cross-sectional views of an internal electrode layer and floating electrode layer of the present disclosure, respectively.

### DETAILED DESCRIPTION

Hereinafter, exemplary embodiments of the present disclosure will be described in detail with reference to the accompanying drawings. The inventive concept may, however, be exemplified in many different forms and should not be construed as being limited to the specific exemplary embodiments set forth herein. Rather, these exemplary embodiments are provided so that this disclosure will be thorough and complete, and will fully convey the scope of the inventive concept to those skilled in the art. In the drawings, the shapes and dimensions of elements may be exaggerated for clarity, and the same reference numerals will be used throughout to designate the same or like elements.

To clarify the present disclosure, portions irrespective of description are omitted and the sizes and dimensions of each component shown in the drawings are arbitrarily shown for convenience of description, and the present disclosure is not necessarily limited to those that are shown. In addition, components with the same functions within the scope of the same concept are described using the same reference numerals. Throughout the specification, unless explicitly described to the contrary, the word “comprise” and variations, such as “comprises” or “comprising,” will be understood to imply the inclusion of stated elements but not the exclusion of any other elements.

In the drawings, the Z-direction may be defined as a thickness direction or a first direction, the X-direction as a length direction or a second direction, and the Y-direction as a width direction or a third direction. Furthermore, a stacking direction may be either the thickness direction or the width direction.

Furthermore, in the present disclosure, “thickness” may refer to a size in the thickness direction or the first direction, “length” may refer to a size in the length direction or the second direction, and “width” may refer to a size in the width direction or the third direction. However, the present disclosure is not particularly limited thereto, and “thickness” may refer to a vertical distance from a reference point or a reference plane to another reference point or another reference plane.

### Multilayer Electronic Component

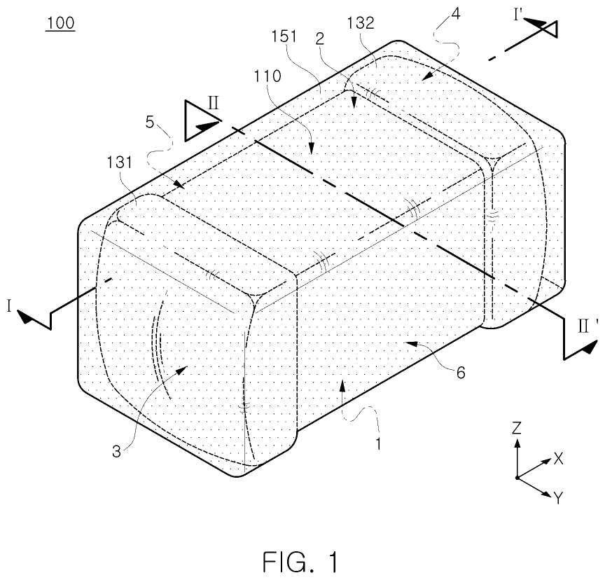

FIG. 1 is a perspective view schematically illustrating a multilayer electronic component according to an exemplary embodiment of the present disclosure.

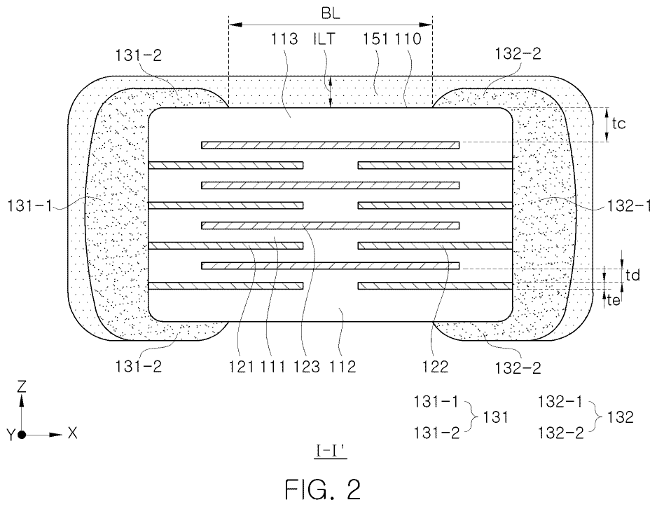

FIG. 2 is a schematic cross-sectional view taken along line I-I′ of FIG. 1.

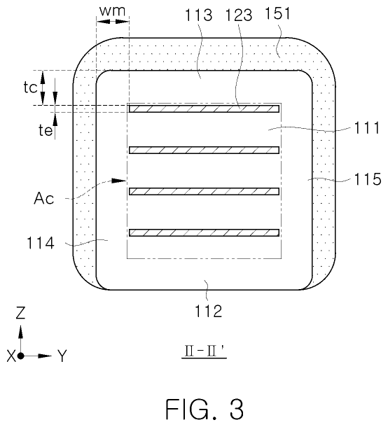

FIG. 3 is a schematic cross-sectional view taken along line II-II′ of FIG. 1.

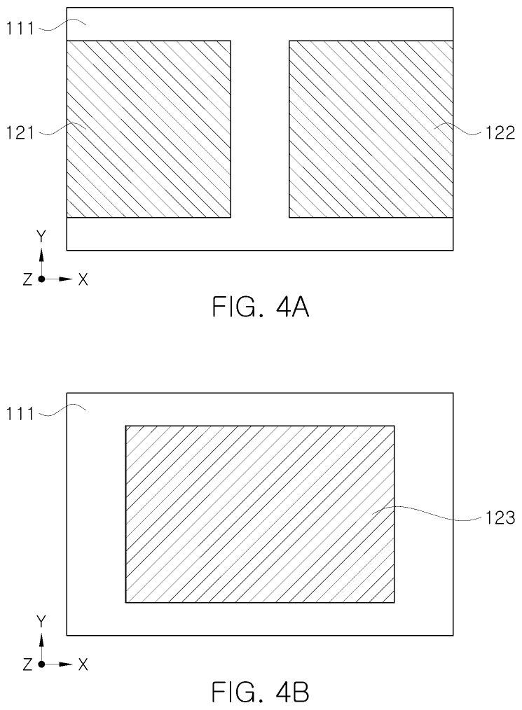

FIGS. 4A and 4B schematically illustrate cross-sectional views of an internal electrode layer and a floating electrode layer of the present disclosure, respectively.

Hereinafter, with reference to FIGS. 1 through 4B, a multilayer electronic component according to an exemplary embodiment of the present disclosure will be described in detail. While a multilayer ceramic capacitor will be described as an example of a multilayer electronic component, the present disclosure may also be applied to various electronic products utilizing dielectric compositions, such as inductors, piezoelectric elements, varistors, or thermistors.

A multilayer electronic component 100 according to an exemplary embodiment of the present disclosure includes a body 110 including a capacitance formation portion Ac including a dielectric layer 111 and an internal electrode layer and a floating electrode layer alternately disposed in the thickness direction with the dielectric layer 111 interposed therebetween and cover portions 112 and 113 respectively disposed on upper (e.g., first surface of the capacitance formation portion Ac) and lower surfaces (e.g., second surface of the capacitance formation portion Ac) of the capacitance formation portion Ac in the thickness direction and including first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction; a first external electrode 131 including a first connection portion 131-1 disposed on the third surface 3 and a first band portion 131-2 extending from the first connection portion 131-1 to a portion on the first and second surfaces 1 and 2; a second external electrode 132 including a second connection portion 132-1 disposed on the fourth surface 4 and a second band portion 132-2 extending from the second connection portion 132-1 to portions on the first and second surfaces 1 and 2; and an insulating layer 151 including silicon (Si) disposed on the body 110, in which and a ratio (tc/BL) of an average thickness tc of the cover portions 112 and 113 to a length BL between the first and second band portions 131-2 and 132-2 may satisfy 0.036≤tc/BL≤1.5.

The multilayer electronic component 100 according to another exemplary embodiment of the present disclosure includes a body 110 including a capacitance formation portion Ac including a dielectric layer 111 and an internal electrode layer and a floating electrode layer alternately disposed in the thickness direction with the dielectric layer 111 interposed therebetween and cover portions 112 and 113 respectively disposed on upper and lower surfaces of the capacitance formation portion Ac in the thickness direction and including first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction; a first external electrode 131 including a first connection portion 131-1 disposed on the third surface 3 and a first band portion 131-2 extending from the first connection portion 131-1 to a portion on the first and second surfaces 1 and 2; a second external electrode 132 including a second connection portion 132-1 disposed on the fourth surface 4 and a second band portion 132-2 extending from the second connection portion 132-1 to portions on the first and second surfaces 1 and 2; and an insulating layer 151 including silicon (Si) disposed on the body 110, in which a ratio (AV/BL) of a voltage AV applied to the multilayer electronic component 100 to a length BL between the first and second band portions 131-2 and 132-2 may satisfy 0.5≤AV/BL≤1.2.

The body 110 may be formed by alternately stacking a dielectric layer 111, an internal electrode layer, and a floating electrode layer.

More specifically, the body 110 may include a capacitance formation portion Ac disposed within the body 110 and including an internal electrode layer and a floating electrode layer alternately arranged with the dielectric layer 111 interposed therebetween to form capacitance.

Although a specific shape of the body 110 is not particularly limited, as shown, the body 110 may have a hexahedral shape or a shape similar thereto. Due to the shrinkage of ceramic particles included in the body 110 during a sintering process, the body 110 may not have a perfectly straight hexahedral shape but may have a substantially hexahedral shape.

The body 110 may have first and second surfaces 1 and 2 opposing each other in the thickness direction, third and fourth surfaces connected to the first and second surfaces 1 and 2 and opposing each other in the length direction, and fifth and sixth surfaces connected to the first to fourth surfaces 1, 2, 3, and 4 and opposing each other in the width direction.

The plurality of dielectric layers 111 forming the body 110 are in a sintered state, and adjacent dielectric layers 111 may be integrated such that it may be difficult to identify a boundary therebetween without using a scanning electron microscope (SEM).

A material for forming the dielectric layer 111 is not limited as long as sufficient capacitance may be obtained. In general, perovskite (ABO₃)-based materials may be used, and for example, a barium titanate-based material, a lead composite perovskite-based material, or a strontium titanate-based material may be used. The barium titanate-based material may include a BaTiO₃-based ceramic particles, and the ceramic particles may include BaTiO₃ and (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1) in which Ca, Zr, and the like are partially dissolved in BaTiO₃.

In addition, as a material for forming the dielectric layer 111, various ceramic additives, organic solvents, binders, dispersants, etc. may be added to powder particles, such as barium titanate (BaTiO₃), according to purposes of the present disclosure.

Meanwhile, to be distinguished from the dielectric layer included in the cover portions 112 and 113 and side margin portions 114 and 115 described below, the dielectric layer included in the capacitance formation portion Ac may be defined as a first dielectric layer, the dielectric layer included in the cover portions 112 and 113 may be defined as a second dielectric layer, and the dielectric layer included in the side margin portions 114 and 115 may be defined as a third dielectric layer.

Furthermore, since the first to third dielectric layers may be formed using a dielectric material, such as barium titanate (BaTiO₃), they may include a dielectric microstructure after sintering. The dielectric microstructure may include a plurality of grains, grain boundaries arranged between adjacent grains, and a triple point disposed at a point at which three or more grain boundaries meet, and may include a plurality of grains, a plurality of grain boundaries, and a plurality of triple points.

A thickness td of the dielectric layer 111 may not be particularly limited.

To ensure reliability of the multilayer electronic component 100 in high-voltage environments, the thickness td of the dielectric layer 111 may be 30 μm or less, 20 μm or less, 10 μm or less, 8 μm or less, 7 μm or less, 6 μm or less, or 5 μm or less. Furthermore, to achieve miniaturization and high capacity of the multilayer electronic component 100, the thickness td of the dielectric layer 111 may be 3.0 μm or less. To facilitate ultra-miniaturization and high capacity, the thickness td of the dielectric layer 111 may be 1.0 μm or less, preferably 0.6 μm or less, and more preferably 0.4 μm or less.

Here, the thickness td of the dielectric layer 111 may refer to the thickness td of the dielectric layer 111 disposed between the internal electrode layer and the floating electrode layer.

At this time, the thickness td of the dielectric layer 111 may refer to the thickness td of any one of the plurality of dielectric layers 111 or may refer to the thickness td of each of all the dielectric layers 111.

Furthermore, the thickness td of the dielectric layer 111 may refer to an average thickness td of one dielectric layer 111, an average thickness td of each of the plurality of dielectric layers 111, or an average thickness td of the plurality of dielectric layers 111.

The average thickness td of the dielectric layer 111 may be measured by scanning an image of a length and thickness-wise cross-section of the body 110 using a scanning electron microscope (SEM) at 10,000× magnification. More specifically, the average thickness td of one dielectric layer 111 may be an average value calculated by measuring thicknesses at five equally spaced points of one dielectric layer 111 in the length direction in the scanned image. These five equally spaced points may be designated in the capacitance formation portion Ac. Furthermore, by extending this average measurement to three dielectric layers 111 and measuring the average value, the average thickness td of a plurality of dielectric layers 111 may be more generalized.

The internal electrode layers and the floating electrode layers may be alternately stacked with the dielectric layer 111.

The internal electrode layer may include a first internal electrode 121 and a second internal electrode 122 arranged on the dielectric layer 111 and spaced apart from each other in the length direction, and the floating electrode layer may include a third internal electrode 123 disposed on the dielectric layer 111 different from the internal electrode layer. The internal electrode layer and the floating electrode layer may be electrically separated from each other by the dielectric layer 111 disposed in between.

More specifically, the first internal electrode 121 and the second internal electrode 122 may be arranged on a single dielectric layer 111 and spaced apart from each other in a length direction. The first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121 exposed to the third surface 3, and a second external electrode 132 may be disposed on the fourth surface 4 of the body 110 and connected to the second internal electrode 122 exposed to the fourth surface 4.

That is, the first internal electrode 121 may be connected to the first external electrode 131 without being connected to the second external electrode 132, and the second internal electrode 122 may be connected to the second external electrode 132 without being connected to the first external electrode 131.

The third internal electrode 123 may be disposed on the dielectric layer 111 different from the internal electrode layer and may be disposed spaced apart from the first and second external electrodes 131 and 132. More specifically, the third internal electrode 123 may be disposed spaced apart from the third to sixth surfaces 3, 4, 5, and 6.

Meanwhile, the body 110 may be formed by alternately stacking a first ceramic green sheet on which a first internal electrode paste, which will become the first internal electrode 121, and a second internal electrode paste, which will become the second internal electrode 122, are printed, and a second ceramic green sheet on which a third internal electrode paste, which will become the third internal electrode 123, is printed, and then firing the first ceramic green sheet and the second ceramic green sheet. The printing method for the conductive paste for the internal electrodes may be a screen printing method or gravure printing method, but the present disclosure is not limited thereto.

The materials forming the first to third internal electrodes 121, 122, and 123 are not particularly limited, and any material with excellent electrical conductivity may be used. For example, the internal electrodes 121 and 122 may include one or more of nickel (Ni), copper (Cu), palladium (Pd), silver (Ag), gold (Au), platinum (Pt), tin (Sn), tungsten (W), titanium (Ti), and alloys thereof.

Meanwhile, a thickness te of the first to third internal electrodes 121, 122, and 123 may not be particularly limited. Hereinafter, the description of the thickness te of the internal electrodes 121, 122, and 123 may refer to the thickness te of each of the first internal electrode 121, the second internal electrode 122, and the third internal electrode 123.

To ensure reliability of the multilayer electronic component 100 in high-voltage environments, the thickness te of the internal electrodes 121, 122, and 123 may be 3.0 μm or less. Furthermore, to achieve miniaturization and high capacity of the multilayer electronic component 100, the thickness te of the internal electrodes 121, 122, and 123 may be 1.0 μm or less. To more easily achieve ultra-miniaturization and high capacity, the thickness te of the internal electrodes 121, 122, and 123 may be 0.6 μm or less, and more preferably 0.4 μm or less.

At this time, the thickness te of the internal electrodes 121, 122, and 123 may be a concept including the thickness te of at least one of the plurality of internal electrodes 121, 122, and 123 or may be a concept including the thickness te of each of the plurality of internal electrodes 121, 122, and 123.

Furthermore, the thickness te of the internal electrodes 121 and 122 may refer to an average thickness te of a single internal electrode 121, 122, and 123, may refer to an average thickness te of each of the plurality of internal electrodes 121, 122, and 123, or may refer to an average thickness te of the plurality of internal electrodes 121, 122, and 123.

The average thickness te of the internal electrodes 121, 122, and 123 may be measured by scanning an image of a length and thickness-wise cross-section of the body 110 using a scanning electron microscope (SEM) at 10,000× magnification. More specifically, the average thickness te of one internal electrode 121 or 122 may be an average value calculated by measuring the thickness of one internal electrode at five equally spaced points in the scanned image in the length direction. These five equally spaced points may be designated in the capacitance formation portion Ac.

Meanwhile, in an exemplary embodiment of the present disclosure, the thickness td of at least one of the plurality of dielectric layers 111 and the thickness te of at least one of the plurality of internal electrodes 121, 122, and 123 may satisfy 2×te<td.

In other words, the thickness td of a single dielectric layer 111 may be greater than twice the thickness te of one internal electrode 121, 122, and 123. Preferably, the average thickness td of a plurality of dielectric layers 111 may be greater than twice the average thickness te of the plurality of internal electrodes 121, 122, and 123.

In general, reliability issues for high-voltage electrical electronic components due to reduced breakdown voltage (BDV) in high-voltage environments are a major concern.

Therefore, to prevent a reduction in breakdown voltage in high-voltage environments, the average thickness td of the dielectric layer 111 may be increased to be more than twice the average thickness te of the internal electrodes 121, 122, and 123, thereby improving breakdown voltage characteristics

If the average thickness td of the dielectric layer 111 is twice or less of the average thickness te of the internal electrodes 121, 122, and 123, the breakdown voltage may decrease and a short circuit may occur between the internal electrodes.

Meanwhile, the body 110 may include cover portions 112 and 113 disposed on both end surfaces of the capacitance formation portion Ac in the thickness direction.

Specifically, the body 110 may include a first cover portion 112 disposed on one surface of the capacitance formation portion Ac in the thickness direction and a second cover portion 113 disposed on the other surface of the capacitance formation portion Ac in the thickness direction. More specifically, for example, the body 110 may include the first cover portion 112 disposed below the capacitance formation portion Ac in the thickness direction and the second cover portion 113 disposed above the capacitance formation portion Ac in the thickness direction.

The first cover portion 112 and the second cover portion 113 may be formed by disposing or stacking a single second dielectric layer or two or more second dielectric layers on the upper and lower surfaces of the capacitance formation portion Ac in the thickness direction, respectively and may fundamentally serve to prevent damage to the internal electrodes 121 and 122 due to physical or chemical stress.

The first cover portion 112 and the second cover portion 113 do not include the internal electrodes 121 and 122 and may include the same dielectric material as the first dielectric layer 111 of the capacitance formation portion Ac. That is, the first cover portion 112 and the second cover portion 113 may include a dielectric material, for example, a barium titanate (BaTiO₃)-based dielectric material.

Meanwhile, the thickness tc of the cover portions 112 and 113 may not be particularly limited. Hereinafter, the description of the thickness tc of the cover portions 112 and 113 may refer to the thickness tc of each of the first cover portion 112 and the second cover portion 113.

In order to maintain reliability of the multilayer electronic component 100 in high-voltage environments, an upper limit of the thickness tc of the cover portions 112 and 113 may be 1200 μm or less, 1100 μm or less, 1000 μm or less, 900 μm or less, 800 μm or less, 700 μm or less, 600 μm or less, 500 μm or less, 400 μm or less, or 300 μm or less, and a lower limit of the thickness tc of the cover portions 112 and 113 may be 100 μm or more, or 200 μm or more. That is, the thickness tc of the cover portions 112 and 113 may satisfy 100 μm≤tc≤1200 μm.

Here, the thickness tc of the cover portions 112 and 113 may refer to the average thickness of the cover portions 112 and 113.

In addition, the average thickness tc of the cover portions 112 and 113 may refer to an average thickness tc of each of the first and second cover portions 112 and 113 or may refer to an average thickness tc of the first and second cover portions 112 and 113.

The average thickness tc of the cover portions 112 and 113 may be measured by scanning an image of a length and thickness-wise cross-section of the body 110 using a scanning electron microscope (SEM) at 10,000× magnification. More specifically, the average thickness tc may refer to an average value calculated by measuring the thicknesses at five equally spaced points in a scanned image of one cover portion 112 or 113 in the length direction. Other methods and/or tools appreciated by one of ordinary skill in the art, even if not described in the present disclosure, may also be used.

In addition, the average thickness tc of the cover portions 112 and 113 measured using the aforementioned method may have a value substantially equal to the average thickness of the cover portions 112 and 113 in the cross-section of the body 110 in the width and thickness directions.

Meanwhile, the multilayer electronic component 100 may include side margin portions 114 and 115, which are widthwise end regions of the internal electrodes 121, 122, and 123.

More specifically, the side margin portions 114 and 115 may include a first side margin portion 114 disposed between the internal electrodes 121, 122, and 123 and the fifth surface 5, and a second side margin portion 115 disposed between the internal electrodes 121, 122, and 123 and the sixth surface 6.

As illustrated, the side margin portions 114 and 115 may refer to a region between both widthwise ends of the third internal electrode 123 and a boundary surface of the body 110, with respect to the width and thickness-wise cross-section of the body 110. In the drawing, only the region between both widthwise ends of the third internal electrode 123 and the boundary surface of the body 110 is illustrated. However, depending on the cross-sectional position in the width and thickness directions, the side margin portions 114 and 115 may also refer to a region between the both widthwise ends of the first to third internal electrodes 121, 122, and 123 and the boundary surface of the body 110.

The side margin portions 114 and 115 may refer to a region of a ceramic green sheet excluding the internal electrodes 121, 122, and 123, when an internal electrode paste is applied to the ceramic green sheet, except for the regions that will become the side margin portions 114 and 115, applied to the capacitance formation portion Ac.

However, the present disclosure is not limited thereto, and the side margin portions 114 and 115 may be formed by forming the internal electrodes 121, 122, and 123 by applying a conductive paste for internal electrodes to the ceramic green sheet applied to the capacitance formation portion Ac, except where the side margin portions 114 and 115 are to be formed, cutting the body 110 so that the internal electrodes 121, 122, and 123 after stacking are exposed to the fifth and sixth surfaces 5 and 6 of the body 110 to suppress a step difference due to the internal electrodes 121, 122, and 123, and then disposing or stacking a single third dielectric layer or two or more third dielectric layers on both widthwise end surfaces of the capacitance formation portion Ac in the width direction.

The side margin portions 114 and 115 may fundamentally serve to prevent damage to the internal electrodes 121, 122, and 123 due to physical or chemical stress.

The side margin portions 114 and 115 do not include the internal electrodes 121, 122, and 123 and may include the same material as the first dielectric layer 111. That is, the first side margin portion 114 and the second side margin portion 115 may include a dielectric material, for example, a barium titanate (BaTiO₃)-based dielectric material.

Meanwhile, a width wm of the side margin portions 114 and 115 may not be particularly limited. Hereinafter, the description of the width wm of the side margin portions 114 and 115 may refer to the width wm of each of the first side margin portion 114 and the second side margin portion 115.

To maintain the reliability of the multilayer electronic component 100 in high-voltage environments, the width wm of the side margin portions 114 and 115 may be 50 μm or less, preferably 30 μm or less, and more preferably 20 μm or less for ultra-small products.

Here, the width wm of the side margin portions 114 and 115 may refer to an average width wm of the side margin portions 114 and 115.

Furthermore, the average width wm of the side margin portions 114 and 115 may refer to the average width wm of each of the first and second side margin portions 114 and 115 or the average width wm of the first and second side margin portions 114 and 115.

The average width wm of the side margin portions 114 and 115 may be measured by scanning an image of a width and thickness-wise cross-section of the body 110 using a scanning electron microscope (SEM) at 10,000× magnification. More specifically, the average width wm of the side margin portions 114 and 115 may refer to an average value calculated by measuring the widths at five equally spaced points in a scanned image of one side margin portion 114 or 115 in the thickness direction.

In an exemplary embodiment of the present disclosure, although the multilayer electronic component 100 having two external electrodes 131 and 132 is described, the number and shape of the external electrodes 131 and 132 may vary depending on the shape of the internal electrodes 121, 122, and 123 or other purposes.

The first and second external electrodes 131 and 132 may be disposed on the body 110 and connected to the first and second internal electrodes 121 and 122, respectively, and may not be connected to the third internal electrode 123.

More specifically, the external electrodes 131 and 132 may be disposed on the third and fourth surfaces 3 and 4 of the body 110, respectively, and may include first and second external electrodes 131 and 132 connected to the first and second internal electrodes 121 and 122, respectively. That is, the first external electrode 131 may be disposed on the third surface 3 of the body and connected to the first internal electrode 121, and the second external electrode 132 may be disposed on the fourth surface 4 of the body and connected to the second internal electrode 122.

Furthermore, the external electrodes 131 and 132 may extend to and disposed on portions of the first and second surfaces 1 and 2 of the body 110 or may extend to and disposed on portions of the fifth and sixth surfaces 5 and 6 of the body 110. That is, the first external electrode 131 may be disposed on the third surface 3 of the body 110 and portions of the first, second, fifth, and sixth surfaces 1, 2, 5, and 6 of the body 110, and the second external electrode 132 may be disposed on the fourth surface 4 of the body 110 and portions of the first, second, fifth, and sixth surfaces 1, 2, 5, and 6 of the body 110.

More specifically, the external electrodes 131 and 132 may include connection portions 131-1 and 132-1 arranged on the third and fourth surfaces 3 and 4 of the body 110 and band portions 131-2 and 132-2 extending from the connection portions 131-1 and 132-1 to portions on the first and second surfaces 1 and 2 of the body 110.

The first external electrode 131 may include a first connection portion 131-1 disposed on the third surface 3 of the body 110 and a first band portion 131-2 extending from the first connection portion 131-1 to portions on the first and second surfaces 1 and 2, and the second external electrode 132 may include a second connection portion 132-1 disposed on the fourth surface 4 of the body 110 and a second band portion 132-2 extending from the second connection portion 132-1 to portions on the first and second surfaces 1 and 2.

The first band portion 131-2 may include a 1-1-th band portion 131-2 extending from the first connection portion 131-1 to a portion on the first surface 1 and a 1-2-th band portion 131-2 extending from the first connection portion 131-1 to a portion on the second surface 2, and the second band portion 132-2 may include a 2-1-th band portion 132-2 extending from the second connection portion 132-1 to a portion on the first surface 1 and a 2-2-th band portion 132-2 extending from the second connection portion 132-1 to a portion on the second surface 2.

In the present disclosure, unless otherwise specifically contradictory, the description of the band portions 131-2 and 132-2 may correspond to the description of each of the first band portion 131-2 and the second band portion 132-2. The description of the first band portion 131-2 may correspond to the description of each of the 1-1-th band portion 131-2 and the 1-2-th band portion 131-2. The description of the second band portion 132-2 may correspond to the description of the 2-1-th band portion 132-2 and the 2-2-th band portion 132-2, respectively.

The length BL between the first band portion 131-2 and the second band portion 132-2 may be 800 μm or more and 2800 μm or less. That is, 800 μm≤BL≤2800 μm may be satisfied.

Here, the length BL between the first band portion 131-2 and the second band portion 132-2 may refer to the length BL between the 1-2-th band portion 131-2 and the 2-2-th band portion 132-2 on the second surface 2 or the length between the 1-1-th band portion 131-2 and the 2-1-th band portion 132-2 on the first surface 1. Preferably, it may refer to the length BL between the 1-2-th band portion 131-2 and the 2-2-th band portion 132-2 on the second surface 2, and more preferably, refer to the shortest length BL.

Since the length BL between the first band portion 131-2 and the second band portion 132-2 satisfies 800 μm≤BL≤2,800 μm, it is possible to prevent the occurrence of an arc, a discharge phenomenon that may occur due to insulation failure between the external electrodes 131 and 132 in high-voltage environments.

If the length BL between the first band portion 131-2 and the second band portion 132-2 is less than 800 μm, the distance between the first and second external electrodes 131 and 132 may be close, which may cause arcing in high-voltage environments, and if the length BL between the first band portion 131-2 and the second band portion 132-2 exceeds 2,800 μm, arcing may not occur, but the area in which the external electrodes 131 and 132 are in contact with the body 110 may be reduced, which may result in peeling of the external electrodes 131 and 132, and furthermore, an application area of solder may be insufficient during mounting on a board, which may result in mounting defects.

Methods for measuring the length BL between the first band portion 131-2 and the second band portion 132-2 may be as follows, but are not particularly limited thereto. First, when a length and thickness-wise cross-section in a widthwise central portion of the multilayer electronic component 100 is observed using a scanning electron microscope (SEM), a length (distance) between a longitudinal end point of the 1-2-th band portion 131-2 on the second surface 2 (e.g., a point in contact with the second surface 2) and a longitudinal end point of the 2-2-th band portion 132-2 on the second surface 2 (e.g., a point in contact with the second surface 2) may be measured and obtained. Other methods and/or tools appreciated by one of ordinary skill in the art, even if not described in the present disclosure, may also be used.

The external electrodes 131 and 132 may be formed using any material having electrical conductivity, such as metal, and a specific material may be determined by considering electrical characteristics, structural stability, and the like and may include an electrode layer. Furthermore, the electrode layer may have a multilayer structure.

For example, the external electrodes 131 and 132 may include a first electrode layer disposed on the body 110 and a second electrode layer disposed on the first electrode layer, and furthermore, may include a third electrode layer disposed on the second electrode layer.

Here, it may be preferable that the first to third electrode layers correspond to layers distinguished from each other. However, without being limited thereto, the first to third electrode layers may be distinguished according to the manufacturing process order, and at least some of the first to third electrode layers may not be distinguished from each other and may be observed as one layer.

In the present disclosure, “distinguished” may refer to that two layers are distinguished due to physical differences, chemical differences, and/or simple optical differences, and layers may be, but are not limited to, distinguished from each other by the presence or absence of an “interface.” The interface may refer to a surface by which two layers in contact with each other are distinguishable from each other, and may refer to, for example, a state in which two layers are distinguishable through differences in components, such as EDS analysis, using equipment, such as a scanning electron microscope (SEM).

The first electrode layer and the second electrode layer may be formed by transferring a sheet including a conductive metal onto the body 110, applying a conductive paste for external electrodes including a conductive metal to the body 110 and then firing the same, or dipping the body 110 in a conductive paste for external electrodes including a conductive metal. However, the present disclosure is not limited thereto.

The external electrodes 131 and 132 may include a first electrode layer disposed on the body 110 and including a first conductive metal and glass and a second electrode layer including a second conductive metal and resin disposed on the first electrode layer.

The conductive metals included in the first and second electrode layers may be materials with excellent electrical conductivity. For example, the conductive metals may include one or more selected from the group consisting of nickel (Ni), copper (Cu), palladium (Pd), silver (Ag), gold (Au), platinum (Pt), tin (Sn), tungsten (W), titanium (Ti), and alloys thereof, but are not particularly limited thereto.

Here, the conductive metal included in the first electrode layer may be referred to as a first conductive metal, and the conductive metal included in the second electrode layer may be referred to as a second conductive metal. The first and second conductive metals may be the same or different. If a plurality of conductive metals are included, only some of the plurality of conductive metals may be the same conductive metals, but the present disclosure is not limited thereto.

The glass included in the first electrode layer may serve to enhance bonding to the body 110. Any material enhancing bonding to the body 110 is not particularly limited. The resin included in the second electrode layer may serve to improve flexural strength. Any resin that may be mixed with the second conductive metal to form a paste is not particularly limited. For example, the resin may include an epoxy-based resin.

The first conductive metal included in the first electrode layer may serve to electrically connect to the internal electrodes 121 and 122.

The first conductive metal included in the first electrode layer is not particularly limited as long as it may be electrically connected to the internal electrodes 121 and 122. For example, the first conductive metal may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layer may serve to electrically connect to the first electrode layer.

The second conductive metal included in the second electrode layer is not particularly limited as long as it may be electrically connected to the first electrode layer, and may include at least one of nickel (Ni), copper (Cu), palladium (Pd), silver (Ag), gold (Au), platinum (Pt), tin (Sn), tungsten (W), titanium (Ti), and alloys thereof.

The second conductive metal included in the second electrode layer may include at least one of spherical particles and flake-shaped particles. Specifically, the second conductive metal may include only flake-shaped particles, only spherical particles, or a mixture of flake-shaped and spherical particles.

Here, the spherical particles may include shapes other than perfectly spherical. For example, the spherical particles may include shapes in which a dimensional ratio (major axis/minor axis) in the major axis and minor axis directions is 1.45 or less. Flake-shaped particles refer to particles with a flat, elongated shape. For example, the dimension ratio of the major axis to the minor axis may be 1.95 or greater, but is not particularly limited. The dimension of the major and minor axes of the spherical particles and flake-shaped particles may be measured from images obtained by scanning length and thickness-wise cross-sections taken from the widthwise center of the multilayer electronic component using a scanning electron microscope (SEM).

Furthermore, the second electrode layer may include an intermetallic compound.

The inclusion of the intermetallic compound may further enhance electrical connectivity with the first electrode layer. The intermetallic compound functions to connect a plurality of second conductive metal particles, thereby enhancing electrical connectivity, and may also surround and connect a plurality of second conductive metal particles.

In this case, the intermetallic compound may include a metal with a melting point lower than a curing temperature of the resin. That is, since the intermetallic compound includes a metal having a melting point lower than the curing temperature of the resin, the metal having a melting point lower than the curing temperature of the resin melts during a drying and curing process, forms an intermetallic compound with a portion of the metal particles, and surrounds the metal particles. At this time, the intermetallic compound may preferably include a low-melting-point metal of 300° C. or lower. More specifically, for example, the intermetallic compound may include tin (Sn) having a melting point of 213 to 220° C. During the drying and curing process, tin (Sn) melts, and the molten tin (Sn) wets high-melting-point metal particles, such as silver (Ag), nickel (Ni), or copper (Cu), by a capillary phenomenon, and reacts with a portion of the silver (Ag), nickel (Ni), or copper (Cu) metal particles to form intermetallic compounds, such as Ag₃Sn, Ni₃Sn₄, Cu₆Sn₅, Cu₃Sn, or the like. Silver (Ag), nickel (Ni), or copper (Cu) not participating in the reaction may remain in the form of metal particles.

Therefore, the plurality of second conductive metal particles may include at least one of silver (Ag), nickel (Ni), and copper (Cu), and the intermetallic compound may include one or more of Ag₃Sn, Ni₃Sn₄, Cu₆Sn₅, and Cu₃Sn.

The third electrode layer may serve to improve mounting characteristics and may be a plating layer formed on the second electrode layer, but is not particularly limited thereto.

The material of the third electrode layer is not particularly limited and may include, for example, at least one of nickel (Ni), tin (Sn), silver (Ag), palladium (Pd), and alloys thereof.

The third electrode layer may be a single layer or a plurality of layers.

More specifically, for example, the third electrode layer may be a nickel (Ni) electrode layer or a tin (Sn) electrode layer and may be formed by sequentially forming a nickel (Ni) electrode layer and a tin (Sn) electrode layer on the second electrode layer. Alternatively, the third electrode layer may be formed by sequentially forming a tin (Sn) electrode layer, a nickel (Ni) electrode layer, and a tin (Sn) electrode layer. Furthermore, the third electrode layer may include a plurality of nickel (Ni) electrode layers and/or a plurality of tin (Sn) electrode layers.

The insulating layer 151 may be disposed on the body 110 and may include silicon (Si).

The insulating layer 151 may prevent arcing, a discharge phenomenon that may occur due to insulation failure between the external electrodes 131 and 132 in high-voltage environments.

The insulating layer 151 may include an insulating material including silicon (Si). More specifically, the insulating layer 151 may include at least one of SiO₂ and Si₃N₄. Furthermore, the insulating layer 151 may be formed by mixing an insulating material including silicon (Si) with additives, such as ZrO₂ or TiO₂.

An average thickness ILT of the insulating layer 151 may be 1 μm or more and 10 μm or less. More specifically, for example, a lower limit may be 1 μm or more, 2 μm or more, 3 μm or more, 4 μm or more, or 5 μm or more, and the upper limit may be 10 μm or less, 9 μm or less, 8 μm or less, 7 μm or less, or 6 μm or less. In other words, the average thickness ILT of the insulating layer 151 may satisfy 1 μm≤ILT≤10 μm.

The method for measuring the average thickness ILT of the insulating layer 151 may be as follows, but is not particularly limited thereto. First, based on the length and thickness-wise cross-section of the multilayer electronic component 100, the thickness of the insulating layer 151 disposed between the first external electrode 131 and the second external electrode 132 may be measured at three points spaced at equal intervals in the length direction using an optical microscope or the like, and the average may be obtained. Other methods and/or tools appreciated by one of ordinary skill in the art, even if not described in the present disclosure, may also be used.

The insulating layer 151 may be disposed on the body 110 or may be disposed on the body 110, the first external electrode 131, and the second external electrode 132.

More specifically, for example, the insulating layer 151 may be disposed on at least one of the first to sixth surfaces 1, 2, 3, 4, 5, and 6, and preferably, on at least one of the second to sixth surfaces 2, 3, 4, 5, and 6. In this case, the insulating layer 151 may be disposed to be in direct contact with the first surface 1 and/or the second surface 2 and the fifth surface 5 and/or the sixth surface 6, may not be in direct contact with the third surface 3 and/or the fourth surface 4, and may be disposed on the third surface 3 and/or the fourth surface 4 with the first and/or second external electrodes 131 and 132 interposed therebetween.

In addition, the insulating layer 151 may be disposed on the first connection portion 131-1 and the first band portion 131-2 and the second connection portion 132-1 and the second band portion 132-2. Preferably, the insulating layer 151 may be disposed on the first connection portion 131-1 and the 1-2-th band portion 131-2 on the second surface 2 and on the second connection portion 132-1 and the 2-2-th band portion 132-2 on the second surface 2.

This may be to improve the mounting performance of the multilayer electronic component 100 on a substrate by not disposing the insulating layer 151 on the mounting surface, for example, the first surface 1, including the 1-1-th band portion 131-2 on the first surface 1 and the 2-1-th band portion 132-2 on the first surface 1.

There is no need to specifically limit the size of the multilayer electronic component 100.

However, to maintain reliability in high-voltage environments, the thickness of the cover portion, the dielectric layer, and/or the internal electrodes should be increased, and therefore, the effects of the present disclosure may be more remarkable in the multilayer electronic component 100 having the size of 2012 mm (length×width: 2.0 mm×1.2 mm, with a length and width within a tolerance of ±10%) or larger. The length and width of the multilayer electronic component 100 may be measured by an optical microscope. Other methods and/or tools appreciated by one of ordinary skill in the art, even if not described in the present disclosure, may also be used.

Although the multilayer electronic component 100 according to an exemplary embodiment of the present disclosure in which the length is greater than the width has been mainly described, the multilayer electronic component 100 according to another exemplary embodiment of the present disclosure may, on the contrary, have a width greater than the length.

In the multilayer electronic component 100 according to an exemplary embodiment of the present disclosure, the ratio (tc/BL) of the average thickness tc of the cover portions 112 and 113 to the length BL between the first and second band portions 131-2 and 132-2 may satisfy 0.036≤tc/BL≤1.5.

Since the ratio (tc/BL) of the average thickness tc of the cover portions 112 and 113 to the length BL between the first and second band portions 131-2 and 132-2 satisfies 0.036≤tc/BL≤1.5, the occurrence of arcing may be prevented, moisture resistance reliability may be improved, and mountability may be excellent.

If the ratio (tc/BL) of the average thickness tc of the cover portions 112 and 113 to the length BL between the first and second band portions 131-2 and 132-2 is less than 0.036, arcing may occur or moisture resistance reliability may deteriorate, and if the ratio (tc/BL) of the average thickness tc of the cover portions 112 and 113 to the length BL between the first and second band portions 131-2 and 132-2 exceeds 1.5, arcing may occur or mounting defects may occur.

At this time, the ratio (AV/BL) of the voltage AV applied to the multilayer electronic component 100 to the length BL between the first and second band portions 131-2 and 132-2 may satisfy 0.5 V/μm≤AV/BL≤1.2 V/μm.

Here, AV may satisfy 630 V≤AV, preferably 630 V≤AV≤3000 V, and may refer to a high voltage in the present disclosure.

At this time, since the ratio (AV/BL) of the voltage AV applied to the multilayer electronic component 100 to the length BL between the first and second band portions 131-2 and 132-2 satisfies 0.5 V/μm≤AV/BL≤1.2 V/μm, arcing may be prevented, moisture resistance reliability may be improved, and mountability may be excellent.

If the ratio (AV/BL) of the voltage applied to the multilayer electronic component 100 to the length BL between the first and second band portions 131-2 and 132-2 is less than 0.5 V/μm, there is a risk of reduced moisture resistance reliability or mounting failure, and if the ratio (AV/BL) of the voltage applied to the multilayer electronic component 100 to the length BL between the first and second band portions 131-2 and 132-2 exceeds 1.2 V/μm, there is a risk of arcing. The voltage AV may be measured by a voltmeter. Other methods and/or tools appreciated by one of ordinary skill in the art, even if not described in the present disclosure, may also be used.

The present disclosure will be described in more detail below through test examples. However, these examples are provided to help in a more specific understanding of the disclosure, and the scope of the present disclosure is not limited by the test examples.

### Test Example

[Table 1] below describes the evaluation of moisture resistance reliability, mounting failures, and arc occurrence according to the ratio (tc/BL) of the average thickness of the cover portion tc to the length BL between the first and second band portions.

A sample chip was manufactured to include a body including a capacitance formation portion in which an internal electrode layer and a floating electrode layer are alternately disposed with a dielectric layer interposed therebetween and a cover portion disposed in a thickness direction of the capacitance formation portion; first and second external electrodes disposed on the third and fourth surfaces of the body, respectively; and an insulating layer disposed on the body and the first and second external electrodes, and the insulating layer was formed on all surfaces except a mounting surface (the first surface) (meaning that the insulating layer was disposed in direct contact with the second, fifth, and sixth surfaces and in direct contact with the first and second external electrodes disposed on the third and fourth surfaces, respectively). The sample chips were manufactured to have the 3225 size (length×width: 3.2 mm×2.5 mm, with a tolerance of ±10%).

For each test example, 320 sample chips were manufactured. The sample chips were manufactured to be the same, except that the average thickness tc of the cover portion and the length BL between the first and second band portions were different.

Based on the length and thickness-wise cross-section of the sample chip, the length BL between the first and second band portions, that is, the distance between the first and second band portions on the surface (the second surface) on which the insulating layer is disposed was measured using an optical microscope, and the average thickness tc of the cover portion (the average thickness tc of the second cover portion (the upper cover portion)) was measured using a scanning electron microscope (SEM).

In the moisture resistance reliability evaluation, 320 sample chips were mounted on a substrate, and a case in which a short circuit occurred when a voltage of 2000 V to 3000 V was applied for 24 hours under conditions of the temperature of 85° C. and the humidity of 85% RH was evaluated as defective and marked as “X,” and a case in which no short circuit occurred was evaluated as normal and marked as “O.”

For mountability, after mounting 320 sample chips on a substrate for evaluating moisture resistance reliability and completing the evaluation of the moisture resistance reliability, a case in which the external electrode was peeled off was evaluated as defective and marked as “X,” and a case in which detachment a sample chip or the external electrode was not peeled off was evaluated as normal and marked as “O.”

For arc, 20 sample chips were mounted on a substrate, and a case in which an arc discharge phenomenon occurred when a voltage of 2000 V to 3000 V was applied at a temperature of 150° C. was marked as “O,” and a case in which an arc discharge phenomenon did not occur was marked as “X.” The case in which an arc discharge phenomenon did not occur was evaluated to have excellent high-temperature reliability.

TABLE 1

| | | | | moisture | | |
|---|---|---|---|---|---|---|
| | tc | BL | | resistance | | |
| | (μm) | (μm) | tc/BL | reliability | Moundability | Arc |
| Test | 80 | 3000 | 0.027 | X | ◯ | ◯ |
| example 1 | | | | | | |
| Test | 100 | 2800 | 0.036 | ◯ | ◯ | X |
| example 2 | | | | | | |
| Test | 400 | 2200 | 0.182 | ◯ | ◯ | X |
| example 3 | | | | | | |
| Test | 800 | 1500 | 0.533 | ◯ | ◯ | X |
| example 4 | | | | | | |
| Test | 1200 | 800 | 1.5 | ◯ | ◯ | X |
| example 5 | | | | | | |
| Test | 1300 | 700 | 1.857 | ◯ | X | ◯ |
| example 6 | | | | | | |

In Test Example 1, with a tc/BL value of 0.027, mountability was excellent, but the moisture resistance reliability was poor and arcing occurred. On the other hand, In Test Examples 2 through 5, with tc/BL values of 0.036 to 1.5, the moisture resistance reliability and mountability were excellent, and arcing did not occur. In Test Example 6, with a tc/BL value of 1.857, moisture resistance reliability was excellent, but mountability was poor and arcing occurred.

From this, it may be confirmed that when the tc/BL value is 0.036 to 1.5, moisture resistance reliability and mountability are excellent and arcing does not occur.

[Table 2] below evaluates the presence or absence of arcing according to the ratio of the applied voltage AV to the length BL between the first and second bands (AV/BL).

The arc was evaluated using the same evaluation method as the test examples described above. A case in which an arc discharge phenomenon occurred was marked as “O,” and a case in which an arc discharge phenomenon did not occur was marked as “X.”

TABLE 2

| | BL | AV | AV/BL | Arc |
|---|---|---|---|---|
| Test example 7 | 1944 μm | 2000 V | 1.03 | X |
| Test example 8 | | 2300 V | 1.18 | X |
| Test example 9 | | 2500 V | 1.29 | ◯ |
| Test example 10 | 1931 μm | 2000 V | 1.04 | X |
| Test example 11 | | 2300 V | 1.19 | X |
| Test example 12 | | 2500 V | 1.29 | ◯ |

In Test Examples 7, 8, 10, and 11, in which the AV/BL values were 1.03, 1.18, 1.04, and 1.19, respectively, no arc discharge occurred. On the other hand, in Test Examples 9 and 12, in which the AV/BL values were 1.29 and 1.29, respectively, arc discharge occurred.

From this, it may be confirmed that arc discharge does not occur when the tc/BL value is 1.2 or less.

One of the various effects of the present disclosure is to improve the reliability of multilayer electronic components in high-voltage environments.

One of the various effects of the present disclosure is to improve the moisture resistance reliability of multilayer electronic components.

One of the various effects of the present disclosure is to improve the mountability of multilayer electronic components.

One of the various effects of the present disclosure is to suppress arcing in multilayer electronic components.

However, the various advantageous and beneficial advantages and effects of the present disclosure are not limited to the above-described contents and will be more easily understood in the process of explaining specific exemplary embodiments of the present disclosure.

Although the exemplary embodiments or experimental examples of the present disclosure have been described in detail above, the present disclosure is not limited to the exemplary embodiments described above and the accompanying drawings, but is intended to be limited by the appended claims. Accordingly, various forms of substitution, modification, and change may be made by those skilled in the art within the scope without departing from the technical idea of the present disclosure described in the claims, and this will also be considered to fall within the scope of the present disclosure.

The expression “an exemplary embodiment or an example” used in the present disclosure does not refer to identical examples and is provided to stress different unique features between each of the examples. However, examples provided in the following description are not excluded from being associated with features of other examples and implemented thereafter. For example, even if matters described in a specific example are not described in a different example thereto, the matters may be understood as being related to the other example, unless otherwise mentioned in descriptions thereof.

The terms used herein are for the purpose of describing particular exemplary embodiments only and are not intended to limit the example exemplary embodiments. As used herein, the singular forms “a,” “an,” and “the” are intended to include the plural forms as well, unless the context clearly indicates otherwise.

What is claimed is:

1. A multilayer electronic component comprising:
a body including:
a capacitance formation portion including:
a dielectric layer; and
an internal electrode layer and a floating electrode layer alternately disposed in a thickness direction with the dielectric layer interposed therebetween; and
a cover portion disposed on each of first and second surfaces of the capacitance formation portion in the thickness direction,
the body including first and second surfaces opposing each other in the thickness direction, third and fourth surfaces connected to the first and second surfaces of the body and opposing each other in a length direction, and fifth and sixth surfaces connected to the first to fourth surfaces of the body and opposing each other in a width direction;
a first external electrode including:
a first connection portion disposed on the third surface of the body, and
a first band portion extending from the first connection portion onto first portions of the first and second surfaces of the body;
a second external electrode including:
a second connection portion disposed on the fourth surface of the body, and
a second band portion extending from the second connection portion onto second portions of the first and second surfaces of the body; and
an insulating layer including silicon (Si) disposed on the body,
wherein a ratio (tc/BL) of an average thickness tc of the cover portion to a length BL between the first and second band portions satisfies 0.036≤tc/BL≤1.5.

2. The multilayer electronic component of claim 1, wherein the length BL satisfies 800 μm≤BL≤2800 μm.

3. The multilayer electronic component of claim 1, wherein the average thickness tc satisfies 100 μm≤tc≤1200 μm.

4. The multilayer electronic component of claim 1, wherein
the internal electrode layer includes:
a first internal electrode extending from the third surface of the body and connected to the first external electrode, and
a second internal electrode extending from the fourth surface of the body and connected to the second external electrode, and
the floating electrode layer includes a third internal electrode spaced apart from the first and second external electrodes.

5. The multilayer electronic component of claim 1, wherein an average thickness ILT of the insulation layer satisfies 1 μm≤ILT≤10 μm.

6. The multilayer electronic component of claim 1, wherein a ratio (AV/BL) of a voltage AV applied to the multilayer electronic component to the length BL satisfies 0.5 V/μm≤AV/BL≤1.2 V/μm.

7. The multilayer electronic component of claim 6, wherein the voltage AV satisfies 630 V≤AV≤3000 V.

8. The multilayer electronic component of claim 1, wherein a length of the multilayer electronic component is 2.0 mm or greater, and a width of the multilayer electronic component is 1.2 mm or greater.

9. A multilayer electronic component comprising:
a body including:
a capacitance formation portion including:
a dielectric layer; and
an internal electrode layer and a floating electrode layer alternately disposed in a thickness direction with the dielectric layer interposed therebetween; and
a cover portion disposed on each of first and second surfaces of the capacitance formation portion in the thickness direction,
the body including first and second surfaces opposing each other in the thickness direction, third and fourth surfaces connected to the first and second surfaces of the body and opposing each other in a length direction, and fifth and sixth surfaces connected to the first to fourth surfaces of the body and opposing each other in a width direction;
a first external electrode including:
a first connection portion disposed on the third surface of the body, and
a first band portion extending from the first connection portion onto first portions of the first and second surfaces of the body;
a second external electrode including:
a second connection portion disposed on the fourth surface of the body, and
a second band portion extending from the second connection portion onto second portions of the first and second surfaces of the body; and
an insulating layer including silicon (Si) disposed on the body,
wherein a ratio (AV/BL) of a voltage AV applied to the multilayer electronic component to a length BL between the first and second band portions satisfies 0.5 V/μm≤AV/BL≤1.2 V/μm.

10. The multilayer electronic component of claim 9, wherein the voltage AV satisfies 630 V≤AV≤3000 V.

11. The multilayer electronic component of claim 10, wherein a ratio (tc/BL) of an average thickness tc of the cover portion to the length BL satisfies 0.036≤tc/BL≤1.5.

12. The multilayer electronic component of claim 11, wherein the length BL satisfies 800 μm≤BL≤2800 μm.

13. The multilayer electronic component of claim 11, wherein the average thickness tc satisfies 100 μm≤tc≤1200 μm.

14. The multilayer electronic component of claim 9, wherein:
the internal electrode layer includes:
a first internal electrode extending from the third surface of the body and connected to the first external electrode, and
a second internal electrode extending from the fourth surface of the body and connected to the second external electrode, and
the floating electrode layer includes a third internal electrode spaced apart from the first and second external electrodes.

15. The multilayer electronic component of claim 9, wherein an average thickness ILT of the insulation layer satisfies 1 μm≤ILT≤10 μm.

16. The multilayer electronic component of claim 9, wherein a length of the multilayer electronic component is 2.0 mm or greater, and a width of the multilayer electronic component is 1.2 mm or greater.
